(19) United States
(12) Patent Application Publication
(10) Pub. No.: US 2018/0024511 A1
(43) Pub. Date: Jan. 25, 2018

(54) MODEL GENERATING METHOD AND APPARATUS

(71) Applicant: Siemens Aktiengesellschaft, Muenchen (DE)

(72) Inventors: Qi WANG, Wuhan (CN); Yong YUAN, Beijing (CN); Ming YU, Wuhan (CN)

(73) Assignee: Siemens Aktiengesellschaft, Muenchen (DE)

(21) Appl. No.: 15/648,569

(22) Filed: Jul. 13, 2017

(30) Foreign Application Priority Data
Jul. 21, 2016 (CN) 201610581342.6

(51) Int. Cl. G05B 13/04; G05B 13/02

(52) U.S. Cl. CPC G05B 13/04; G05B 13/0265

(57) ABSTRACT

An embodiment of the present invention relates to a model generating method and apparatus, for realizing automatic creation of a system model. A model generating method of an embodiment includes: collecting configuration information of a system; extracting semantic description information from the configuration information; generating a model of the system according to the semantic description information, the model of the system including a relationship between model nodes and the model nodes corresponding to a device in the system or data produced by a device in the system. By extracting semantic description information from configuration information to generate a system model, a method for realizing automatic creation of a system model is provided, giving higher precision than manual creation of a system model.

### PRIORITY STATEMENT

The present application hereby claims priority under 35 U.S.C. §119 to Chinese patent application number CN 201610581342.6 filed Jul. 21, 2016, the entire contents of which are hereby incorporated herein by reference.

### FIELD

At least one embodiment of the present invention generally relates to the technical field of production management, in particular to a model generating method and apparatus.

### BACKGROUND ART

A system such as a factory generally contains hundreds of devices, for example sensors, controllers, materials, components, products, etc. One method which may be chosen to achieve automatic control and processing of devices in a system is to generate a model to describe the system, such that the system becomes structured, and on the basis of the model, subject devices in the system to control and data processing.

At present, models are usually generated manually. Manual generation of a model generally takes a long time, and places considerable demands on the specialist knowledge of the people generating the model; they must have an in-depth understanding of the system, for example: know the meaning of data in the system, system processing logic and relevant parameters, etc. If staff lack specialist knowledge, then it is very difficult to generate a precise model.

### SUMMARY

In view of the above, an embodiment of the present invention provides a model generating method and apparatus, for realizing automatic creation of a system model, wherein the model created is highly precise.

To realize automatic creation of a system model, in an embodiment of the present invention, semantic description information is extracted from system configuration information, then a system model is generated according to the semantic description information.

In a first aspect, an embodiment of the present invention provides a model generating method, which method is used for generating a model of a system, and comprises: collecting configuration information of the system; extracting semantic description information from the configuration information; and generating a model of the system according to the semantic description information.

In a second aspect, an embodiment of the present invention provides a model generating apparatus, for generating a model of a system, comprising:

a configuration information collecting module, for collecting configuration information of the system;

a semantic description information extracting module, for extracting semantic description information from the configuration information; and

a model generating module, for generating a model of the system according to the semantic description information.

In a third aspect, an embodiment of the present invention provides a model generating apparatus, for generating a model of a system, comprising:

a memory, for storing a computer instruction;

a processor, for calling the computer instruction to execute the method provided in any embodiment in the first aspect or the second aspect.

In a fourth aspect, an embodiment of the present invention provides a computer readable medium, on which is stored a computer instruction which, when executed by a processor, causes the processor to execute the method provided in any embodiment in the first aspect or the second aspect.

### BRIEF DESCRIPTION OF THE ACCOMPANYING DRAWINGS

FIG. 1 is a flow chart of a model generating method provided in an embodiment of the present invention.

FIG. 2 is a schematic diagram of a system model generated using an embodiment of the present invention.

FIG. 3 is an example of system configuration information.

FIG. 4 is a flow chart of a method provided in an embodiment of the present invention for generating a system model according to semantic description information.

FIG. 5 is a flow chart of another model generating method provided in an embodiment of the present invention.

FIG. 6 is a schematic diagram of a time series in an embodiment of the present invention.

FIG. 7 is a flow chart of another model generating method provided in an embodiment of the present invention.

FIG. 8 is a structural schematic diagram of a model generating apparatus provided in an embodiment of the present invention.

FIG. 9 is a structural schematic diagram of another model generating apparatus provided in an embodiment of the present invention.

FIGS. 10 and 11 show examples of a process of generating a system model in an embodiment of the present invention.

FIG. 12 is a structural schematic diagram of another model generating apparatus provided in an embodiment of the present invention.

In the drawings:

S101: collect system configuration information

S102: extract semantic description information

S103: generate system model

201: sensor A 202: sensor B 203: sensor C 204: sensor D

301: data H 302: data I 303: data J 304: data K

305: data L 306: data M 307: data N 308: data O

R1: adjacent R2: father-child R3: before R4: corresponding R5: cause and effect R6: after

U1: Server U2: S7 U3: @LOCALSERVER U4: S7_Connection_1

U5: Consistence (consistency) U6: statepath (state path) U7: blocks

U8: db U9: db1 U901: db1.0,b U902: length U903: db1.0,c

S3021: identify model node

S3032: generate sub-model

S3033: integrate system model

S104: obtain adjusted system model

O: output t: time

S105: update training rule

80: model generating apparatus 801: configuration information collecting module 802: semantic description information extracting module

803: model generating module 804: model adjusting module

10: on-site system 20: data point list 30: configuration information from control platform

40: time series 50: configuration information from auxiliary tool 60: initial model

70: adjusted model 90: training rule library

1201: memory 1202: processor

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

In a first aspect, an embodiment of the present invention provides a model generating method, which method is used for generating a model of a system, and comprises: collecting configuration information of the system; extracting semantic description information from the configuration information; and generating a model of the system according to the semantic description information.

The model of the system comprises at least two model nodes and a relationship between the at least two model nodes; and each of the at least two model nodes corresponds to a device in the system or data produced by a device in the system.

In the method provided in the first aspect of an embodiment, semantic description information is acquired from system configuration information, then a system model is generated according to the semantic description information; thus a method for automatically generating a system model is provided, which gives higher model precision than a method of manually generating a model.

Furthermore, the model generated comprises model nodes and a relationship between model nodes. The model nodes correspond to devices in the system or to data produced by devices in the system. In the past, system models only described devices in a system and a connection relationship between devices, failing to take into account data produced by devices, or the relationships between different items of data produced by devices or between data and devices. However, when a system is operating, there is not only interaction between devices; data produced by devices also contains abundant information in itself, and data produced by one device might have an effect on the operation of another device. Here, not just devices but also data produced by devices are taken into account; not just relationships between devices but also relationships between devices and data, and between items of data, are taken into account. Thus the system model generated is better able to accurately reflect the system operating process and data interaction, and the generated model is more precise.

In the method provided in the first aspect of an embodiment, configuration information of the system may be collected in at least one of the following ways:

collecting configuration information of the system from at least two devices in the system respectively;

collecting configuration information of the system from at least one controller which controls an operating process of at least one device in the system;

collecting configuration information of the system from at least one control platform which controls an operating process of at least one device in the system;

receiving manually inputted configuration information of the system; and

collecting configuration information of the system from at least one auxiliary device, which auxiliary device is used for monitoring an operating state of at least one device in the system and/or for collecting information of at least one device in the system.

In this optional embodiment, configuration information may be collected form various parts of the system, so that the configuration information collected is more comprehensive, and the model generated is more precise.

The system configuration information collected may comprise at least one of the following information:

description information of data produced during operation of at least one device in the system;

description information of at least one device in the system;

process control information for controlling an operating process of at least one device in the system; and

information for describing logic for realizing a function of the system.

In this optional embodiment, various types of configuration information may be collected; different items of configuration information describe system configuration from different perspectives, such that the collected information is more diverse, and the generated model is more precise.

In the method provided in the first aspect of an embodiment, optionally, the semantic description information may be extracted from the configuration information according to a keyword in the configuration information.

The keyword is used to indicate at least one of the following relationships:

a portion of description in the configuration information being an attribute of a device in the system;

a portion of description in the configuration information being an attribute of data produced by a device in the system;

a relationship between a device corresponding to a portion of description in the configuration information and another device corresponding to another portion of description;

a relationship between data produced by a device corresponding to a portion of description in the configuration information and other data produced by said device corresponding to another portion of description or data produced by another device;

a relationship between data produced by a device corresponding to a portion of description in the configuration information and said device corresponding to another portion of description or another device.

In this optional embodiment, semantic description information is extracted from the configuration information according to a keyword; thus a solution for extracting semantic description information is provided.

Optionally, in the case where the semantic description information extracted comprises at least two items of information, the following steps may be employed when generating the model of the system according to the semantic description information:

for each item of a portion of or all information of the semantic description information, identifying at least two model nodes associated with said item of information;

generating a sub-model for each item of the portion of or all information, the sub-model comprising at least two model nodes associated with said item of information and/or a relationship between at least two model nodes associated with said item of information;

integrating all the sub-models generated to form a model of the system, according to all model nodes associated with the portion of or all information.

In this optional embodiment, first of all sub-models are generated, then the generated sub-models are integrated to form a system model according to a relationship between model nodes in each sub-model; thus a solution for system model integration is provided.

In the method provided in the first aspect of an embodiment, optionally, after generating a model of the system according to the semantic description information, an adjusted model of the system may also be obtained on the basis of the generated model of the system.

If at least two models of the system are generated according to the semantic description information, then when performing system model adjustment, one of the at least two generated models of the system may be selected to serve as an adjusted model of the system.

If one model of the system is generated according to the semantic description information, then when performing system model adjustment, the generated model of the system may be adjusted, to obtain an adjusted model of the system.

In this optional embodiment, after generating the system model, the model is adjusted; the adjusted model is more precise.

Optionally, an adjusted model of the system is obtained according to real-time data, wherein the real-time data is data produced by at least one device in the system during operation of the system.

In this optional embodiment, a model is adjusted according to real-time data; real-time operation of the system is taken into account, and the adjusted model is more precise.

Optionally, an adjusted model of the system is obtained according to a training rule, wherein the training rule comprises a rule to which a relationship between different types of at least two model nodes of the model conforms.

In this optional embodiment, model adjustment is performed according to a relationship between types of model nodes; thus the relationship between model nodes is taken into account, and a solution for model verification and adjustment is provided.

Optionally, when the model of the system is adjusted according to real-time data, adjustment may be performed in the following way:

first of all, for each of at least two model nodes in the model of the system, performing the following operations:

acquiring data produced at at least two times respectively during operation of the system by a device in the system corresponding to the model node;

forming the data produced at the at least two times respectively into a time series according to chronological order;

determining a time variation trend of variation with time of the time series;

then obtaining an adjusted model of the system according to a relationship between the time variation trends corresponding to the at least two model nodes respectively.

In this optional embodiment, a relationship between variation trends of data produced by different model nodes is taken into account, thereby providing a solution for verifying and adjusting a model.

Optionally, after obtaining an adjusted model of the system on the basis of the generated model of the system, the method further comprises: updating the training rule according to the adjusted model of the system.

In this optional embodiment, a training rule is updated according to the adjusted system model, so that when a model is generated again subsequently or a model is adjusted, the model is more precise.

In a second aspect, an embodiment of the present invention provides a model generating apparatus, for generating a model of a system, comprising:

a configuration information collecting module, for collecting configuration information of the system;

a semantic description information extracting module, for extracting semantic description information from the configuration information; and

a model generating module, for generating a model of the system according to the semantic description information.

The model of the system comprises at least two model nodes and a relationship between the at least two model nodes; and each of the at least two model nodes corresponds to a device in the system or data produced by a device in the system.

Semantic description information is acquired from system configuration information, then a system model is generated according to the semantic description information; thus a method for automatically generating a system model is provided, which gives higher model precision than a method of manually generating a model.

Furthermore, the model generated comprises model nodes and a relationship between model nodes. The model nodes correspond to devices in the system or to data produced by devices in the system. In the past, system models only described devices in a system and a connection relationship between devices, failing to take into account data produced by devices, or the relationships between different items of data produced by devices or between data and devices. However, when a system is operating, there is not only interaction between devices; data produced by devices also contains abundant information in itself, and data produced by one device might have an effect on the operation of another device. Here, not just devices but also data produced by devices are taken into account; not just relationships between devices but also relationships between devices and data, and between items of data, are taken into account. Thus the system model generated is better able to accurately reflect the system operating process and data interaction, and the generated model is more precise.

Optionally, the configuration information collecting module may collect configuration information of the system in at least one of the following ways:

collecting configuration information of the system from at least two devices in the system respectively;

collecting configuration information of the system from at least one controller which controls an operating process of at least one device in the system;

collecting configuration information of the system from at least one control platform which controls an operating process of at least one device in the system;

receiving manually inputted configuration information of the system; and

collecting configuration information of the system from at least one auxiliary device, which auxiliary device is used for monitoring an operating state of at least one device in the system and/or for collecting information of at least one device in the system.

In this optional embodiment, configuration information may be collected form various parts of the system, so that the configuration information collected is more comprehensive, and the model generated is more precise.

Optionally, the configuration information comprises at least one of the following information:

description information of data produced during operation of at least one device in the system;

description information of at least one device in the system;

process control information for controlling an operating process of at least one device in the system;

information for describing logic for realizing a function of the system.

In this optional embodiment, various types of configuration information may be collected; different items of configuration information describe system configuration from different perspectives, such that the collected information is more diverse, and the generated model is more precise.

Optionally, the semantic description information extracting module may extract the semantic description information from the configuration information according to a keyword in the configuration information.

The keyword is used to indicate at least one of the following relationships:

a portion of description in the configuration information being an attribute of a device in the system;

a portion of description in the configuration information being an attribute of data produced by a device in the system;

a relationship between a device corresponding to a portion of description in the configuration information and another device corresponding to another portion of description;

a relationship between data produced by a device corresponding to a portion of description in the configuration information and other data produced by said device corresponding to another portion of description or data produced by another device;

a relationship between data produced by a device corresponding to a portion of description in the configuration information and said device corresponding to another portion of description or another device.

In this optional embodiment, semantic description information is extracted from the configuration information according to a keyword; thus a solution for extracting semantic description information is provided.

Optionally, the semantic description information extracted by the semantic description information extracting module comprises at least two items of information; in this case, the model generating module may specifically be used for:

for each item of a portion of or all information of the semantic description information, identifying at least two model nodes associated with said item of information;

generating a sub-model for each item of the portion of or all information, the sub-model comprising at least two model nodes associated with said item of information and/or a relationship between at least two model nodes associated with said item of information;

integrating all the sub-models generated to form a model of the system, according to all model nodes associated with the portion of or all information.

In this optional embodiment, first of all sub-models are generated, then the generated sub-models are integrated to form a system model according to a relationship between model nodes in each sub-model; thus a solution for system model integration is provided.

Optionally, the apparatus further comprises: a model adjusting module, for obtaining an adjusted model of the system on the basis of a model of the system generated by the model generating module.

If the model generating module generates at least two models of the system, then the model adjusting module selects one of the at least two models generated by the model generating module to serve as an adjusted model of the system.

Alternatively, if the model generating module generates one model of the system, then the model adjusting module adjusts the one model generated by the model generating module, to obtain an adjusted model of the system.

In this optional embodiment, after generating the system model, the model is adjusted; the adjusted model is more precise.

Optionally, the model adjusting module may obtain an adjusted model of the system according to real-time data, wherein the real-time data is data produced by at least one device in the system during operation of the system.

In this optional embodiment, a model is adjusted according to real-time data; real-time operation of the system is taken into account, and the adjusted model is more precise.

Optionally, the model adjusting module may obtain an adjusted model of the system according to a training rule, wherein the training rule comprises a rule to which a relationship between different types of at least two model nodes of the model conforms.

In this optional embodiment, model adjustment is performed according to a relationship between types of model nodes; thus the relationship between model nodes is taken into account, and a solution for model verification and adjustment is provided.

Optionally, the model adjusting module may employ the following steps to adjust the model of the system according to real-time data:

first of all, for each of at least two model nodes in the model of the system, performing the following operations:

acquiring data produced at at least two times respectively during operation of the system by a device in the system corresponding to the model node;

forming the data produced at the at least two times respectively into a time series according to chronological order;

determining a time variation trend of variation with time of the time series;

then obtaining an adjusted model of the system according to a relationship between the time variation trends corresponding to the at least two model nodes respectively.

In this optional embodiment, a relationship between variation trends of data produced by different model nodes is taken into account, thereby providing a solution for verifying and adjusting a model.

Optionally, the model adjusting module is further used for: after obtaining an adjusted model of the system, updating the training rule according to the adjusted model of the system.

In this optional embodiment, a training rule is updated according to the adjusted system model, so that when a model is generated again subsequently or a model is adjusted, the model is more precise.

In a third aspect, an embodiment of the present invention provides a model generating apparatus, for generating a model of a system, comprising:

a memory, for storing a computer instruction;

a processor, for calling the computer instruction to execute the method provided in any embodiment in the first aspect or the second aspect.

Semantic description information is acquired from system configuration information, then a system model is generated according to the semantic description information; thus a method for automatically generating a system model is provided, which gives higher model precision than a method of manually generating a model. Furthermore, the model generated comprises model nodes and a relationship between model nodes. The model nodes correspond to devices in the system or to data produced by devices in the system. In the past, system models only described devices in a system and a connection relationship between devices, failing to take into account data produced by devices, or the relationships between different items of data produced by devices or between data and devices. However, when a system is operating, there is not only interaction between devices; data produced by devices also contains abundant information in itself, and data produced by one device might have an effect on the operation of another device. Here, not just devices but also data produced by devices are taken into account; not just relationships between devices but also relationships between devices and data, and between items of data, are taken into account. Thus the system model generated is better able to accurately reflect the system operating process and data interaction, and the generated model is more precise.

In a fourth aspect, an embodiment of the present invention provides a computer readable medium, on which is stored a computer instruction which, when executed by a processor, causes the processor to execute the method provided in any embodiment in the first aspect or the second aspect.

Semantic description information is acquired from system configuration information, then a system model is generated according to the semantic description information; thus a method for automatically generating a system model is provided, which gives higher model precision than a method of manually generating a model. Furthermore, the model generated comprises model nodes and a relationship between model nodes. The model nodes correspond to devices in the system or to data produced by devices in the system. In the past, system models only described devices in a system and a connection relationship between devices, failing to take into account data produced by devices, or the relationships between different items of data produced by devices or between data and devices. However, when a system is operating, there is not only interaction between devices; data produced by devices also contains abundant information in itself, and data produced by one device might have an effect on the operation of another device. Here, not just devices but also data produced by devices are taken into account; not just relationships between devices but also relationships between devices and data, and between items of data, are taken into account. Thus the system model generated is better able to accurately reflect the system operating process and data interaction, and the generated model is more precise.

As stated above, a system such as a factory generally contains a huge number of devices of numerous types, e.g. sensors, controllers, materials, components, products, etc. One feasible way of realizing control of these devices of numerous types in the system is to establish a model for describing the system, and on the basis of the system model, subject the devices in the system to control and data processing. However, the question of how to generate a precise model, that is capable of accurately representing the various devices in the system, is a problem which is urgently in need of a solution.

In view of the fact that system configuration information is the basis for operation of devices in the system as well as for cooperation among devices, each device operates strictly in accordance with configuration information. Therefore, in embodiments of the present invention, consideration is given to generation of a system model on the basis of system configuration information.

However, system configuration information can exist in many forms, the contents of which are different from one another. Manual generation of a model takes a long time, and places considerable demands on the specialist knowledge of personnel, and the generated model might not be sufficiently precise. Therefore, an embodiment of the present invention provides a solution in which a system model is generated automatically on the basis of system configuration information. Specifically, semantic description information is extracted from system configuration information, then a system model is generated according to the semantic description information.

A model generating method and apparatus provided in an embodiment of the present invention are explained in detail below with reference to the accompanying drawings.

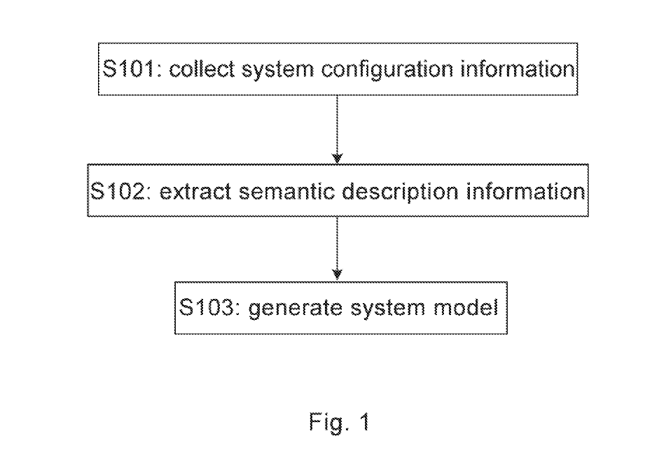

FIG. 1 is a flow chart of a model generating method provided in an embodiment of the present invention. As FIG. 1 shows, the flow comprises the following steps:

S101: collecting configuration information of a system;

S102: extracting semantic description information from the configuration information;

S103: generating a model of the system according to the semantic description information.

In the flow, the extraction of semantic description information from the system configuration information makes use of abundant information used to describe devices, device operating processes and data produced by devices etc. within the system configuration information. The complete nature of the information makes the system model that is generated more precise. Furthermore, through the extraction of semantic description information from configuration information, useful information for generating the system model is acquired, the system model is generated on the basis of the configuration information, and automatic generation of the system model is realized.

System configuration information may include but is not limited to one or more of the following items of information:

information for configuring an attribute of at least one device in the system;

information for controlling an operating process of at least one device in the system;

information for configuring data produced during operation of at least one device in the system;

information for configuring a connection relationship between at least two devices in the system;

information for controlling interaction between at least two devices in the system.

Based on these abundant items of system configuration information, abundant semantic description information can be extracted, so that the model generated is better able to reflect the true operating condition of the system, and the model is more precise.

In an embodiment of the present invention, a system model comprises at least two model nodes and a relationship between these at least two model nodes. One model node corresponds to one device in the system or to data produced by one device in the system. In the past, system models only described at least two devices in a system and a connection relationship between at least two devices, failing to take into account data produced by devices, or the relationships between different items of data produced by devices or between data and devices. However, when a system is operating, there is not only interaction between devices; data produced by devices also contains abundant information in itself, and data produced by one device might have an effect on the operation of another device. In embodiments of the present invention, not just devices but also data produced by devices are taken into account; not just relationships between devices but also relationships between devices and data, and between items of data, are taken into account. Thus the system model generated is better able to accurately reflect the system operating process and data interaction, and is therefore more precise.

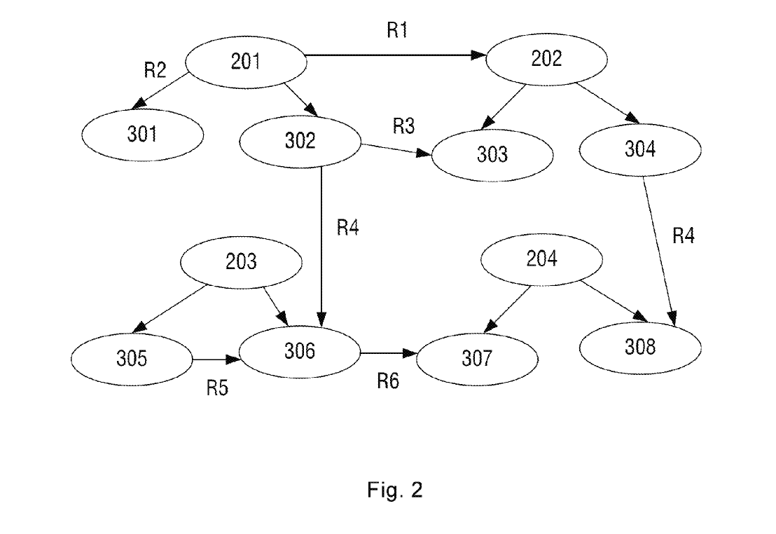

FIG. 2 shows a simple example of a system model in an embodiment of the present invention. Each oval in FIG. 2 represents a model node. The connecting lines between model nodes represent relationships between model nodes. A sensor A 201 and a sensor B 202 have an adjacency relationship; sensor A 201 and data H 301 have a father-child relationship therebetween, indicating that data H 301 is produced by sensor A 201. The relationship between data I 302 and data J 303 is that data I 302 is produced before data J 303. Data I 302 corresponds to data M 306; data K 304 corresponds to data O 308. A sensor C 203 produces data L 305 and data M 306; a sensor D 204 produces data N 307 and data O 308. Data M 306 is produced before data N 307; data L 305 is the reason for the production of data M 306.

Optionally, system configuration information may be collected from different points in the system. For example:

System configuration information is collected from at least two devices in the system.

System configuration information is collected from at least one controller, e.g. a programmable logic controller (PLC), which controls an operating process of at least one device in the system.

System configuration information is collected from at least one control platform which controls an operating process of at least one device in the system; these control platforms may be: a Process Control System (PCS) 7 platform, an Information Technology (IT) system, a control platform using a Human Machine Interface (HMI), a control platform on which PLC programming software STEP7 has been installed, and a control platform using Windows Control Center (WinCC), etc.

The configuration information may also be manually inputted system configuration information.

Furthermore, system configuration information may also be collected from at least one auxiliary device, which auxiliary device is used for monitoring an operating state of at least one device in the system and/or for collecting information of at least one device in the system. For example, a worker holds a scanner and scans a barcode on a material; the scanner can then be regarded as an auxiliary device, while the barcode scanned by the scanner can serve as configuration information. As another example: a Radio Frequency Identification (RFID) reader/writer may monitor relative positions of devices; the RFID reader/writer can then be regarded as an auxiliary device, while the information about relative positions that is obtained by monitoring can serve as configuration information.

In an embodiment of the present invention, the system may comprise devices such as controllers, devices and control platforms which actually operate in the system; therefore, we also refer to the system formed by these devices as an “on-site system”. An auxiliary tool may be regarded as a device outside the on-site system, and performs an auxiliary action on system operation.

Configuration information collection positions have been described above; the content which may be contained in configuration information is described below:

Description information of data produced during operation of at least one device in the system. In an embodiment of the present invention, description information of these items of data may form a data point list (data list). Each record in the data point list may comprise a data name and/or identifier, and optionally, may also comprise a simple description of data.

Description information of at least one device in the system, e.g.: information described using Electronic Device Description Language (EDDL); these items of information may be acquired from devices.

Process control information for controlling an operating process of at least one device in a system, e.g. process control information described in a system description file complying with an embedded OLE for Process Control (OPC) Unified Architecture (UA) standard used for connection of a process control object, a tag list from a WinCC control platform, etc.

Information for describing logic for realizing system functions, e.g.: information in Function Input/Output (Function IO) or Standard Template Library (STL) script written using STEP7.

Optionally, in step S102, semantic description information may be extracted from configuration information according to a keyword in the configuration information. The keyword is used to indicate at least one of the following relationships:

a portion of description in the configuration information being an attribute of a device in the system;

a portion of description in the configuration information being an attribute of data produced by a device in the system;

a relationship between a device corresponding to a portion of description in the configuration information and a device corresponding to another portion of description;

a relationship between data produced by a device corresponding to a portion of description in the configuration information and data produced by said device corresponding to another portion of description;

a relationship between data produced by a device corresponding to a portion of description in the configuration information and data produced by another device corresponding to another portion of description;

a relationship between data produced by a device corresponding to a portion of description in the configuration information and said device corresponding to another portion of description;

a relationship between data produced by a device corresponding to a portion of description in the configuration information and another device corresponding to another portion of description.

An input of step S102 is various types of configuration information; the ways in which these are expressed each have their own distinctive features. In this step, optionally, semantic description information in various types of configuration information is extracted, and expressed using a unified semantic language, e.g.: a language complying with the OPC UA or Resource Description Framework (RDF) standard.

Using a unified semantic language for expression facilitates combination of items of semantic description information in step S103, to be analyzed to generate an integrated model.

Some examples of semantic description information generated are given below:

Variable1 isChildOf Device1 (Variable 1 is Child Of Device 1).

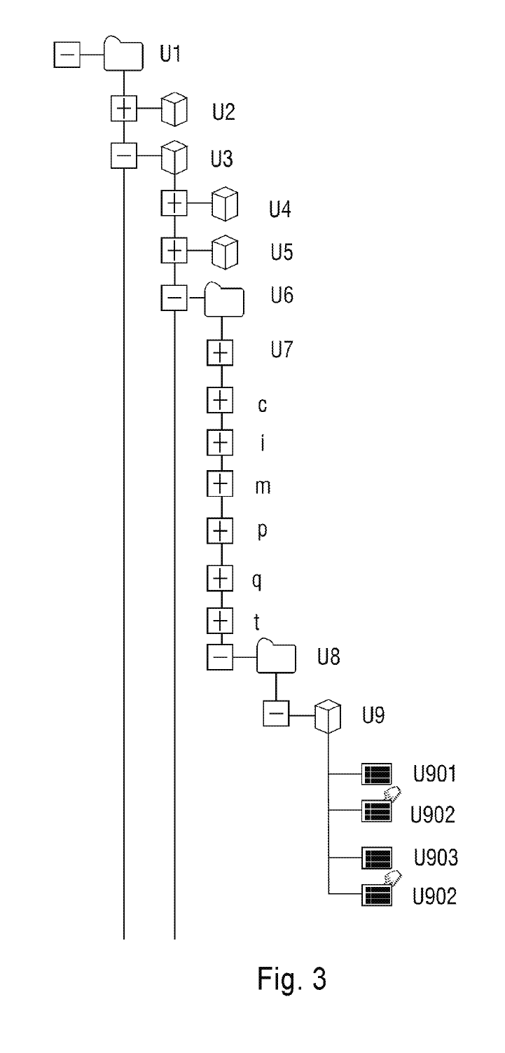

For example, referring to the structure table of an OPC UA server shown in FIG. 3, it can be seen that db1.0,b U901 is a child of db1 U9, and db1 U9 is a child of db U8. It must be explained that the structure table of the OPC UA server has been given here in order to facilitate understanding; in fact, such a structure is described by means of a program language complying with the OPC UA standard. There are keywords in a statement used to describe the abovementioned structure table, for indicating that db1.0,b U901 is a child of db1 U9, and db1 U9 is a child of db U8. In step S102, keywords may be extracted from these programs, and a relationship between objects to which the keywords are connected is determined according to the keywords.

Variable2 isRelatedTo Variable3 (Variable 2 is Related To Variable 3).

Again referring to FIG. 3, the two variables db1.0,b U901 and db1.0,c U903 are related.

Variable4 isTypeOf Type1 (Variable 4 is Variable of Type 1)

See the EDDL description below:

```
  #define LINEAR 0
  VARIABLE trans1_temperature_unit
  {
  LABEL [digital_units];
  HELP [temperature_unit_help];
  CLASS CONTAINED
  HANDLING READ & WRITE
  TYPE ENUMERATED (2)
  {
  DEFAULT VALUE 32,
  {32, [degC], [degC_help]},
  {33, [degF], [degF_help]},
  {34, [degR], [degR_help]},
  {35, [Kelvin], [Kelvin_help]},
  IF (trans1_sensor_type = LINEAR)
  {
      { 36, [mV], [mV_help] },
      { 37, [Ohm], [Ohm] },
      { 39, [mA], [mA_help] },
    }
  }
}
```

In this EDDL description, general words and translations have been used with reference to a text dictionary, and a condition description is used to define read/write processing of e.g. a value range, general survey and any other parameter.

On the basis of a keyword CLASS in EDDL, it can be determined that: a variable trans1_temperature_unit is of an ENUMERATED type.

Device2 isTypeOf Type2 (Type Of Device 2 is Type 2).

Variable5 isInputOf Function1 (Variable 5 is Input Of Function 1); Variable6 isOutputOf Function1 (Variable 6 is Output of Function 1).

See the inputs/outputs of function blocks from STEP7 shown in table 1 below:

TABLE 1

| Hierarchy | Chart | Block | I/O name | Value | Unit | Signal | Identifier |
|---|---|---|---|---|---|---|---|
| Plant\Unit_A\Function(1)\ | TEST | Accumulate | EN | 1 | | | |
| Plant\Unit_A\Function(1)\ | TEST | Accumulate | ADDEND | | | TEST_ADD added | |
| Plant\Unit_A\Function(1)\ | TEST | Accumulate | SUM | | | TEST_ADD sum | |
| Plant\Unit_A\Function(1)\ | TEST | Accumulate | ENO | 0 | | | |
| Plant\Unit_A\Function(1)\ | TEST | Light | EN | 1 | | | |
| Plant\Unit_A\Function(1)\ | TEST | Light | IN1 | | | LIGHT_SWITCH_DOWN | |
| Plant\Unit_A\Function(1)\ | TEST | Light | IN2 | | | LIGHT_SWITCH_UP | |
| Plant\Unit_A\Function(1)\ | TEST | Light | ENO | 0 | | | |
| Plant\Unit_A\Function(1)\ | TEST | Light | OUT1 | 0 | | LIGHT_CONTROL | |

With regard to the variable LIGHT_SWITCH_DOWN in Signals, it can be determined on the basis of the corresponding IN1 in the I/O names that this variable is an input signal of the Block Light; by the same principle, it can be determined that the signal LIGHT_CONTROL is an output signal of the Block Light.

Furthermore, an adjacency relationship between devices can also be determined on the basis of configuration information collected by an auxiliary device (e.g. an RFID reader/writer). This adjacency relationship may be described as: Device3 isNearBy Device4 (Device 3 is adjacent to Device 4).

For example: device 3 and device 4 each have an RFID electronic tag adhered thereto, and an RFID reader/writer reads wireless signals emitted by the electronic tags of these two devices; it can be determined that the devices are adjacent according to the strength and angle of wireless signals received.

As another example, device 3 and device 4 each have a QR code tag adhered thereto; a mobile phone having a Global Positioning System (GPS) locating function and a QR code scanning function is used to scan the QR code tags on the two devices separately, to learn identity information of the two devices, and GPS position information is recorded at the time of scanning. It can be determined that the two devices are adjacent on the basis of the device identity information and GPS position information acquired.

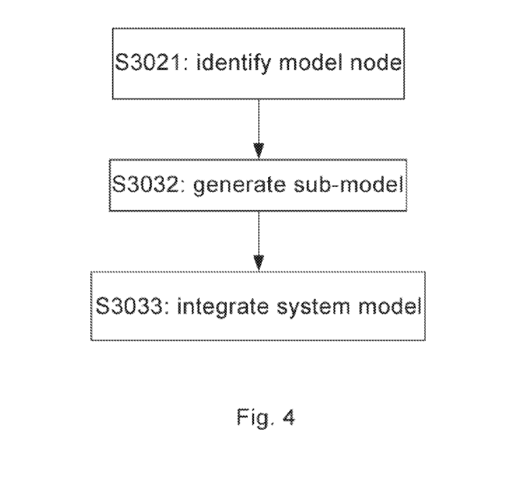

If the semantic description information extracted in step S302 comprises at least two items of information, then as shown in FIG. 4, the following sub-steps may be used in step S303 to generate the system model:

S3021: for each item of a portion of or all semantic description information, identifying a model node associated with said item of information;

S3032: generating a sub-model for each item of a portion of or all information, the sub-model comprising at least two model nodes associated with said item of information and/or a relationship between at least two model nodes associated with said item of information;

S3033: integrating all the sub-models generated to forma system model, according to all identified model nodes associated with a portion of or all information.

In step S3033, sub-models may be integrated to form a system model according to identical model nodes in all sub-models generated.

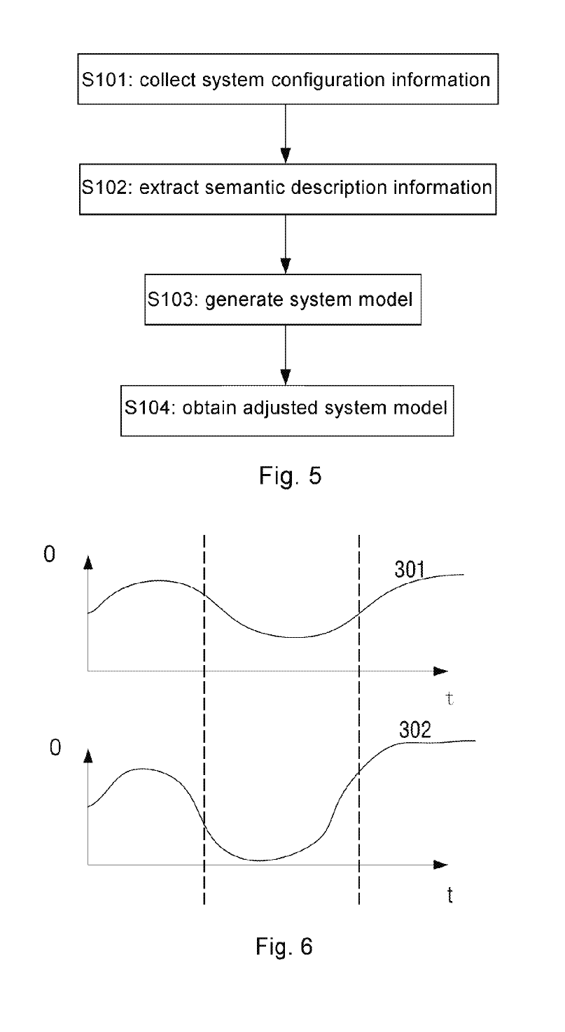

Optionally, as FIG. 5 shows, after step S103, the method further comprises:

step S104: obtaining an adjusted system model on the basis of the system model generated in step S103.

In step S103, at least two models of the system might be generated according to semantic description information; then in step S104, one model may be selected from the at least two models of the system that are generated, to serve as the adjusted system model.

Alternatively, in step S103, one model of one system having a portion of undetermined model nodes is generated, and in step S104, the undetermined model nodes are determined through adjustment. Since the undetermined model nodes may have more than one possible implementation, different implementations may also be regarded as different system models.

Alternatively, in step S103, one model of the system is generated according to semantic description information; then in step S104, the system model generated in step S103 is adjusted to obtain the adjusted system model.

Specifically, the adjusted system model may be obtained according to real-time data; or the adjusted system model may be obtained according to a training rule; or the adjusted system model may be obtained according to real-time data and according to a training rule.

The real-time data is: data produced by at least one device in the system during operation of the system. The training rule comprises: a rule to which a relationship between different types of at least two model nodes of the model conforms.

Some examples of training rules are given below:

Tag1 isChildOf Tag2 on possibility 80% (the possibility of tag 1 being a child of tag 2 is 80%).

Tag3 isNearBy Tag4 on possibility 70% (the possibility of tag 3 being adjacent to tag 4 is 70%).

Tag5 isCauseBy Tag6 on possibility 90% (the possibility of tag 5 being caused by tag 6 is 90%).

Tag7 isRelatedTo Tag8 on possibility 85% (the possibility of tag 7 being related to tag 8 is 85%).

For example: a temperature sensor corresponds to one class of model node, a humidity sensor corresponds to another class of model node, and temperature corresponds to another class of model node. The model node corresponding to temperature might be a child of the model node corresponding to the temperature sensor, but will not be a child of the model node corresponding to the humidity sensor.

In the abovementioned training rules, the tags are model nodes. The training rules may be stored in a training rule library; training rules may be extracted from trained models, and re-used in other processes of generating models. Based on existing semantic technology, a tag of an identifier, name or title may be extracted and classified. Reference relationships between tags may be counted, and inputted into rules in the form of possibilities. These rules may serve as a reference for other model generation processes. This is beneficial for the rapid generation of models in the same field or similar fields.

Optionally, the following method may be used to adjust a system model according to real-time data:

for each of at least two model nodes in the system model, performing the following operations:

acquiring data produced at at least two times respectively during system operation by a device in the system corresponding to the model node;

forming the data produced at at least two times respectively into a data time series according to chronological order;

determining a trend of variation with time of the time series;

obtaining an adjusted system model according to a relationship between trends of variation with time of time series corresponding to the at least two model nodes respectively.

A relationship between items of data may be determined on the basis of an existing method such as data analysis. For example: a data analysis method is used to identify data 1 as varying with data 2. Referring to FIG. 6, a time series graph of data 1 may be obtained on the basis of data of collected data 1; a time series graph of data 2 may be obtained on the basis of data of collected data 2. By comparing the two time series graphs, it is determined that data 1 varies in a manner which follows close behind the variation of data 2. Based on the relationship between time series corresponding to obtained data 1 and data 2 respectively, the relationship between model nodes in the system model can be verified, and it is also possible to add the relationship between model nodes in the generated model, to enrich the model.

One possible manner of implementation is as follows: a model is adjusted both according to a training rule and according to real-time data. Optionally, step S104 may comprise the following sub-steps:

according to a training rule, and on the basis of multiple system models generated in step S103, calculating a possibility of each model;

analyzing a data time series according to collected real-time data, to detect a relationship between items of data;

wherein the execution of the two sub-steps mentioned above has no set order; it is possible to perform the first sub-step first, and then perform the second sub-step, or to perform the second sub-step first, and then perform the first sub-step, or to perform both sub-steps at the same time.

Furthermore, also included are the following sub-steps:

determining which model has the highest possibility with reference to real-time data;

adjusting a model according to an analysis result, removing an impossible part, and adding a part which might be missing;

obtaining an adjusted system model.

Since a time series occurs continuously, the model will be adjusted according to an analysis result if the relationship between items of data changes.

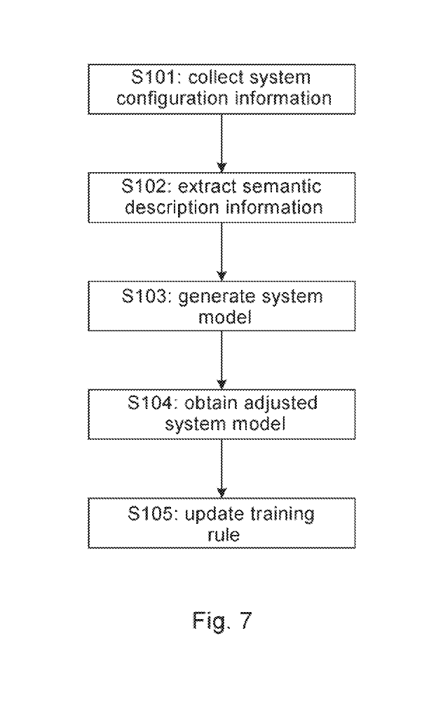

Optionally, referring to FIG. 7, after step S104, the method may further comprise:

step S105: updating a training rule according to an adjusted system model. The updated training rule may be stored in a training rule library.

In the flows shown in FIGS. 5 and 7, the adjustment of a system model according to real-time data and/or a training rule can make the system model more precise.

In an embodiment of the present invention, a generated system model may help to develop a greater number of valuable applications, e.g.: error diagnosis, process monitoring or process simulation, etc.

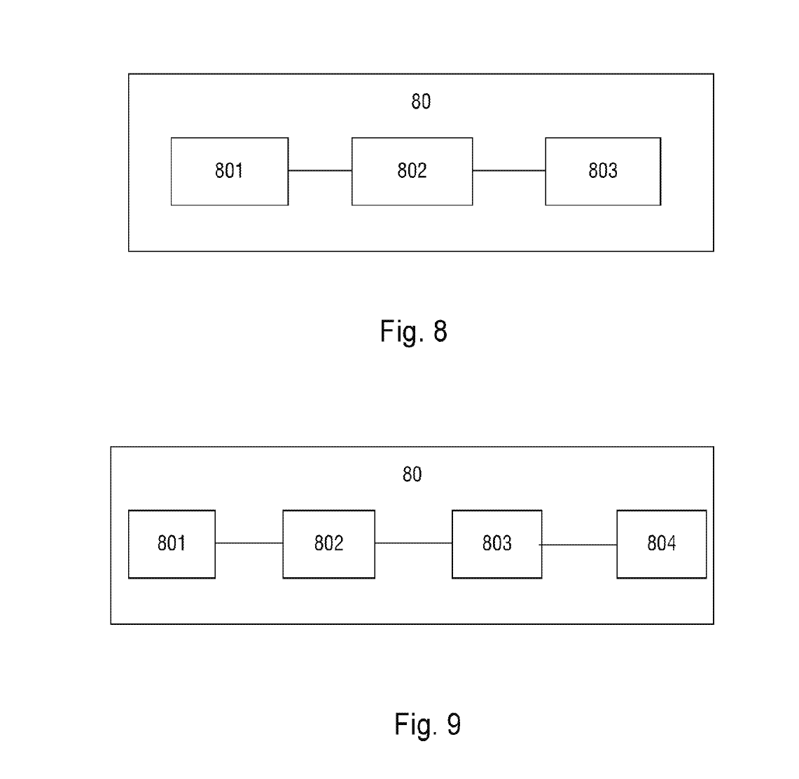

Referring to FIG. 8, an embodiment of the present invention also provides a model generating apparatus 80, comprising:

a configuration information collecting module 801, for collecting configuration information of a system; the configuration information being used to configure an attribute of a device in the system, an operating process of a device, data produced during operation of a device, a connection relationship between devices, and interaction between devices;

a semantic description information extracting module 802, for extracting semantic description information from configuration information;

a model generating module 803, for generating a system model according to semantic description information;

wherein the system model comprises at least two model nodes and a relationship between the at least two model nodes;

each model node corresponds to one device in the system or to data produced by one device in the system.

Optionally, the configuration information collecting module 801 is specifically used for collecting system configuration information in at least one of the following ways:

collecting system configuration information from at least two devices in the system;

collecting system configuration information from at least one controller which controls an operating process of at least one device in the system;

collecting system configuration information from at least one control platform which controls an operating process of at least one device in the system;

receiving manually inputted system configuration information;

collecting system configuration information from at least one auxiliary device, which auxiliary device is used for monitoring an operating state of at least one device in the system and/or for collecting information of at least one device in the system.

Optionally, the configuration information comprises at least one of the following information:

description information of data produced during operation of at least one device in the system;

description information of at least one device in the system;

process control information for controlling an operating process of at least one device in the system;

information for describing logic for realizing system functions.

Optionally, the semantic description information extracting module 802 is specifically used for: extracting semantic description information from configuration information according to a keyword in the configuration information; wherein the keyword can indicate at least one of the following relationships:

a portion of description in the configuration information being an attribute of a device in the system;

a portion of description in the configuration information being an attribute of data produced by a device in the system;

a relationship between a device corresponding to a portion of description in the configuration information and another device corresponding to another portion of description;

a relationship between data produced by a device corresponding to a portion of description in the configuration information and data produced by said device corresponding to another portion of description;

a relationship between data produced by a device corresponding to a portion of description in the configuration information and data produced by another device corresponding to another portion of description;

a relationship between data produced by a device corresponding to a portion of description in the configuration information and said device corresponding to another portion of description;

a relationship between data produced by a device corresponding to a portion of description in the configuration information and another device corresponding to another portion of description.

Optionally, semantic description information extracted by the semantic description information extracting module 802 comprises at least two items of information; and the model generating module is specifically used for:

for each item of a portion of or all semantic description information, identifying at least two model nodes associated with said item of information;

generating a sub-model for each item of a portion of or all information, the sub-model comprising the identified at least two model nodes associated with said item of information and/or a relationship between the identified at least two model nodes associated with said item of information;

integrating all the sub-models generated to forma system model, according to all identified model nodes associated with a portion of or all information.

Optionally, as FIG. 9 shows, the apparatus also comprises: a model adjusting module 804, for obtaining an adjusted system model on the basis of a system model generated by the model generating module 803;

wherein the model generating module 803 generates at least two models of the system; and the model adjusting module 804 is specifically used for: selecting one of the at least two models generated by the model generating module 803 to serve as the adjusted system model; or

the model generating module 803 generates one model of the system; and the model adjusting module 804 is specifically used for: adjusting the one model generated by the model generating module, to obtain the adjusted system model.

Optionally, the model adjusting module 804 is specifically used for:

obtaining an adjusted system model according to real-time data; and/or

obtaining an adjusted system model according to a training rule;

wherein the real-time data is: data produced by at least one device in the system during operation of the system;

the training rule comprises: a rule to which a relationship between different types of at least two model nodes of the model conforms.

Optionally, the model adjusting module 804, when adjusting the system model according to real-time data, is specifically used for:

for each of at least two model nodes in the system model, performing the following operations:

acquiring data produced at at least two times respectively during system operation by a device in the system corresponding to the model node;

forming the data produced at at least two times respectively into a data time series according to chronological order;

determining a trend of variation with time of the time series;

obtaining an adjusted system model according to a relationship between trends of variation with time of time series corresponding to the at least two model nodes respectively.

Optionally, the model adjusting module 804 is also used for:

after obtaining an adjusted system model, updating a training rule according to the adjusted system model.

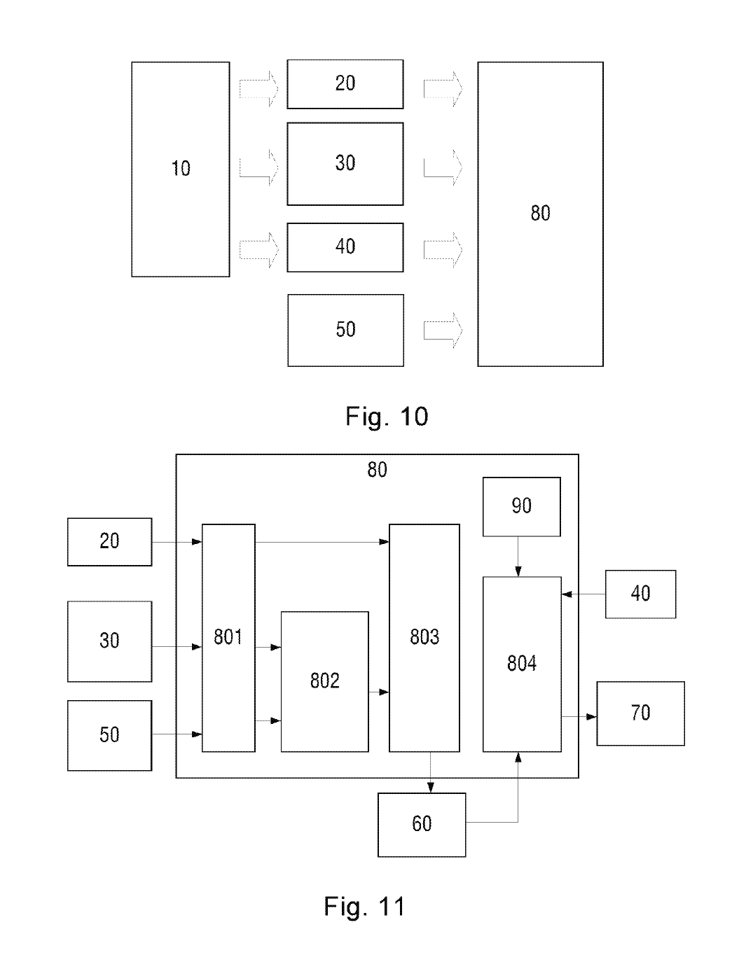

Referring to FIGS. 10 and 11, examples are given below to explain how the model generating apparatus provided in an embodiment of the present invention is implemented.

Referring to FIG. 10, a data point list 20 from an on-site system and configuration information 30 from a control platform (e.g. description, structure, script, etc.) are inputted into a model generating apparatus 80 provided in an embodiment of the present invention. In addition, optionally, configuration information 50 from an auxiliary tool may also be inputted. These items of confirmation information are processed by the model generating apparatus 80, to generate a system model. Here, a time series 40 is real-time data collected during system operation, and as an input to the model generating apparatus 80, can realize verification and updating of a model generated by the model generating apparatus.

Referring to FIG. 11, FIG. 11 shows not only information exchange between the model generating apparatus 80 and the outside world, but also one possible manner of implementation within the model generating apparatus 80.

As FIG. 11 shows, the configuration information collecting module 801 collects various types of configuration information. The semantic description information extracting module 802 extracts semantic description information from the collected configuration information 50 from the auxiliary tool and the configuration information 30 from the control platform, for the model generating module 803 to generate an initial model 60. When generating the initial model 60, the model generating module 803 also makes use of the data point list 20 collected by the configuration information collecting module 801; data points in the data point list 20 respectively correspond to model nodes in a model, and are used to integrate generated sub-models to form a system model. Based on a training rule in a training rule library 90 and the time series 40 formed by collected real-time data, the model adjusting module 804 subjects the initial model to training and adjustment to form an adjusted model 70, also called a “trained model”; furthermore, the model adjusting module 804 may also update training rules according to the adjusted model 70, and store these in the training rule library 90. The training rule library 90 may be integrated in the model generating apparatus 80, or separately stored in a storage device.

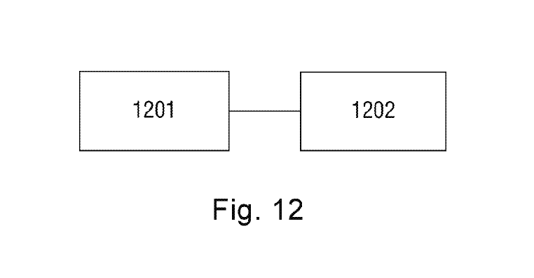

Furthermore, as shown in FIG. 12, an embodiment of the present invention provides another model generating apparatus 80, comprising:

a memory 1201, for storing a computer instruction;

a processor 1202, for calling a computer instruction to execute the model generating method provided in an embodiment of the present invention.

An embodiment of the present invention also provides a computer storage medium, storing an instruction for causing a machine to execute a checking method for a program code according to the present text. Specifically, a system or apparatus equipped with a storage medium may be provided; software program code realizing functions of any one of the embodiments above is stored on the storage medium, and a computer (or CPU or MPU) of the system or apparatus is caused to read and execute program code stored in the storage medium.

In such a situation, program code read from a storage medium can itself realize functions of any one of the embodiments above, hence the program code and the storage medium storing the program code form part of the present invention.

Examples of storage media used for providing program code include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, program code may be downloaded from a server computer via a communication network.

Furthermore, it should be clear that an operating system operating on a computer can be made to complete a portion of or all actual operations, not only through execution of program code read by a computer, but also by means of instructions based on program code, so as to realize functions of any one of the embodiments above.

In addition, it can be appreciated that program code read out from the storage medium is written into a memory installed in an expansion board inserted in the computer, or written into a memory installed in an expansion unit connected to the computer, and thereafter instructions based on the program code make a CPU etc. installed on the expansion board or expansion unit execute part or all of an actual operation, so as to realize the function of any one of the embodiments above.

In summary, in an embodiment of the present invention, semantic description information is acquired from system configuration information, then a system model is generated according to the semantic description information; a method for automatically generating a system model is provided. Compared with a method for manually generating a model, the model precision is higher.

Furthermore, the model generated in an embodiment of the present invention comprises model nodes and a relationship between model nodes. The model nodes correspond to devices in the system or to data produced by devices in the system. In the past, system models only described devices in a system and a connection relationship between devices, failing to take into account data produced by devices, or the relationships between different items of data produced by devices or between data and devices. However, when a system is operating, there is not only interaction between devices; data produced by devices also contains abundant information in itself, and data produced by one device might have an effect on the operation of another device. In embodiments of the present invention, not just devices but also data produced by devices are taken into account; not just relationships between devices but also relationships between devices and data, and between items of data, are taken into account. Thus the system model generated is better able to accurately reflect the system operating process and data interaction, and the generated model is more precise.

It must be explained that not all of the steps and modules in the flows and system structure diagrams above are necessary; certain steps or modules may be omitted according to actual requirements. The order in which steps are executed is not fixed, but may be adjusted as required. The system structures described in the embodiments above may be physical structures, and may also be logical structures, i.e. some modules might be realized by the same physical entity, or some modules might be realized by multiple physical entities, or realized jointly by certain components in multiple independent devices.

In the embodiments above, a hardware unit may be realized in a mechanical or an electrical manner. For example, a hardware unit may comprise a permanent dedicated circuit or logic (e.g. a special processor, FPGA or ASIC) to complete a corresponding operation. A hardware unit may also comprise programmable logic or circuitry (e.g. a universal processor or another programmable processor), and may be set temporarily by software to complete a corresponding operation. Particular embodiments (mechanical, or dedicated permanent circuitry, or temporarily set circuitry) may be determined on the basis of considerations of cost and time.

The present invention has been displayed and explained in detail above by means of the accompanying drawings and preferred embodiments, but the present invention is not limited to these disclosed embodiments. Based on the embodiments described above, those skilled in the art will know that further embodiments of the present invention, also falling within the scope of protection of the present invention, could be obtained by combining code checking means in different embodiments above.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A model generating method to generate a model of a system, comprising:
collecting configuration information of the system;
extracting semantic description information from the configuration information;
generating a model of the system according to the semantic description information, wherein
the model of the system includes at least two model nodes and a relationship between the at least two model nodes, and wherein each of the at least two model nodes corresponds to a device in the system or data produced by a device in the system.

2. The method as claimed in claim 1, wherein the collecting of the configuration information of the system comprises collecting configuration information of the system in at least one of the following ways:
collecting configuration information of the system from at least two devices in the system, respectively;
collecting configuration information of the system from at least one controller which controls an operating process of at least one device in the system;
collecting configuration information of the system from at least one control platform which controls an operating process of at least one device in the system;
receiving manually inputted configuration information of the system; and
collecting configuration information of the system from at least one auxiliary device, the auxiliary device being usable for at least one of monitoring an operating state of at least one device in the system and collecting information of at least one device in the system.

3. The method of claim 1, wherein the configuration information comprises at least one of the following:
description information of data produced during operation of at least one device in the system;
description information of at least one device in the system;
process control information for controlling an operating process of at least one device in the system; and
information for describing logic for realizing a function of the system.

4. The method of claim 1, wherein the extracting of the semantic description information from the configuration information comprises:
extracting the semantic description information from the configuration information according to a keyword in the configuration information, wherein the keyword is used to indicate at least one of the following relationships:
a portion of description in the configuration information being an attribute of a device in the system;
a portion of description in the configuration information being an attribute of data produced by a device in the system;
a relationship between a device corresponding to a portion of description in the configuration information and another device corresponding to another portion of description;
a relationship between data produced by a device corresponding to a portion of description in the configuration information and other data produced by said device corresponding to another portion of description or data produced by another device; and
a relationship between data produced by a device corresponding to a portion of description in the configuration information and said device corresponding to another portion of description or another device.

5. The method of claim 1, wherein semantic description information of the system comprises at least two items of information, and the generating of the model of the system according to the semantic description information comprises:
identifying, for each item of a portion of or all information of the semantic description information, at least two model nodes associated with said item of information;
generating a sub-model for each item of the portion of or all information, the sub-model comprising at least two model nodes associated with at least one of said item of information and a relationship between at least two model nodes associated with said item of information; and
integrating the sub-models generated to form a model of the system, according to the model nodes associated with a portion of or all of the information.

6. The method of claim 1, further comprising:
obtaining, after generating a model of the system according to the semantic description information, an adjusted model of the system on the basis of the generated model of the system; wherein the generating of the model of the system according to the semantic description information comprises:
generating at least two models of the system according to the semantic description information, and
wherein either
the obtaining of the adjusted model of the system on the basis of the generated model of the system comprises:
selecting one of the at least two generated models of the system to serve as an adjusted model of the system; or
the generating of the model of the system according to the semantic description information comprises:
generating one model of the system according to the semantic description information, and
the obtaining of the adjusted model of the system on the basis of the generated model of the system comprises:
adjusting the generated model of the system, to obtain an adjusted model of the system.

7. The method of claim 6, wherein the obtaining of the adjusted model of the system on the basis of the generated model of the system comprises at least one of:
obtaining an adjusted model of the system according to real-time data; wherein the real-time data is data produced by at least one device in the system during operation of the system; and
obtaining an adjusted model of the system according to a training rule; wherein the training rule comprises a rule to which a relationship between different types of at least two model nodes of the model conforms.

8. The method of claim 7, wherein the adjusting of the model of the system according to real-time data comprises:
performing, for each of at least two model nodes in the model of the system, the following operations:
acquiring data produced at at least two times respectively during operation of the system by a device in the system corresponding to the model node;
forming the data produced at the at least two times respectively into a time series according to chronological order;
determining a time variation trend of variation with time of the time series; and
obtaining an adjusted model of the system according to a relationship between the time variation trends corresponding to the at least two model nodes respectively.

9. The method of claim 7, further comprising:
updating, after obtaining an adjusted model of the system on the basis of the generated model of the system, the training rule according to the adjusted model of the system.

10. A model generating apparatus to generate a model of a system, comprising:
a configuration information collecting module, to collect configuration information of the system;
a semantic description information extracting module, to extract semantic description information from the configuration information;
a model generating module, to generate a model of the system according to the semantic description information, wherein the model of the system includes at least two model nodes and a relationship between the at least two model nodes, and wherein each of the at least two model nodes corresponds to a device in the system or data produced by a device in the system.

11. The apparatus of claim 10, wherein the configuration information collecting module is configured to collect the configuration information of the system in at least one of the following ways:
collecting configuration information of the system from at least two devices in the system respectively;
collecting configuration information of the system from at least one controller which controls an operating process of at least one device in the system;
collecting configuration information of the system from at least one control platform which controls an operating process of at least one device in the system;
receiving manually inputted configuration information of the system; and
collecting configuration information of the system from at least one auxiliary device, the auxiliary device being configured to at least one of monitor an operating state of at least one device in the system and collect information of at least one device in the system.

12. The apparatus of claim 10, wherein the configuration information comprises at least one of the following information:
description information of data produced during operation of at least one device in the system;
description information of at least one device in the system; process control information for controlling an operating process of at least one device in the system; and
information for describing logic for realizing a function of the system.

13. The apparatus of claim 10, wherein the semantic description information extracting module is configured to extract the semantic description information from the configuration information according to a keyword in the configuration information, wherein the keyword is used to indicate at least one of the following relationships:
a portion of description in the configuration information being an attribute of a device in the system;
a portion of description in the configuration information being an attribute of data produced by a device in the system;
a relationship between a device corresponding to a portion of description in the configuration information and another device corresponding to another portion of description;
a relationship between data produced by a device corresponding to a portion of description in the configuration information and other data produced by said device corresponding to another portion of description or data produced by another device; and
a relationship between data produced by a device corresponding to a portion of description in the configuration information and said device corresponding to another portion of description or another device.

14. The apparatus of claim 10, wherein the semantic description information extracted by the semantic description information extracting module includes at least two items of information, and the model generating module is configured to:
for each item of a portion of or all information of the semantic description information,
identifying at least two model nodes associated with said item of information;
generating a sub-model for each item of the portion of or all information, the sub-model comprising at least two model nodes associated with said item of information and/or a relationship between at least two model nodes associated with said item of information; and
integrating all the sub-models generated to form a model of the system, according to all model nodes associated with the portion of or all information.

15. The apparatus of claim 10, further comprising:
a model adjusting module, to obtain an adjusted model of the system on the basis of a model of the system generated by the model generating module wherein
the model generating module is configured to generate at least two models of the system, and the model adjusting module is configured to select one of the at least two models generated by the model generating module to serve as an adjusted model of the system;
or
the model generating module is configured to generate one model of the system, and the model adjusting module is configured to adjust the one model generated by the model generating module, to obtain an adjusted model of the system.

16. The apparatus of claim 15, wherein the model adjusting module is configured to at least one of:
obtain an adjusted model of the system according to real-time data, wherein the real-time data is data produced by at least one device in the system during operation of the system;
and
obtain an adjusted model of the system according to a training rule, the training rule including a rule to which a relationship between different types of at least two model nodes of the model conforms.

17. The apparatus of claim 16, wherein the model adjusting module, when adjusting a model of the system according to real-time data, is configured to, for each of at least two model nodes in the model of the system, perform the following operations:
acquiring data produced at at least two times respectively during operation of the system by a device in the system corresponding to the model node;
forming the data produced at the at least two times respectively into a time series according to chronological order;
determining a time variation trend of variation with time of the time series; and
obtaining an adjusted model of the system according to a relationship between the time variation trends corresponding to the at least two model nodes respectively.

18. The apparatus of claim 16, wherein the model adjusting module is further configured to:
update, after obtaining an adjusted model of the system, the training rule according to the adjusted model of the system.

19. A model generating apparatus, configured to generate a model of a system, comprising:
a memory to store at least one computer instruction; and
at least one processor, to call the at least one computer instruction to:
collect configuration information of the system;
extract semantic description information from the configuration information;
generate a model of the system according to the semantic description information, wherein the model of the system includes at least two model nodes and a relationship between the at least two model nodes, and wherein each of the at least two model nodes corresponds to a device in the system or data produced by a device in the system.

20. A non-transitory computer readable medium, on which is stored at least one computer instruction which, when executed by a processor, causes the processor to execute the method of claim 1.

21. The method of claim 2, wherein the configuration information comprises at least one of the following:
description information of data produced during operation of at least one device in the system;
description information of at least one device in the system;
process control information for controlling an operating process of at least one device in the system; and
information for describing logic for realizing a function of the system.

22. The method of claim 8, further comprising:
updating, after obtaining an adjusted model of the system on the basis of the generated model of the system, the training rule according to the adjusted model of the system.

23. The apparatus of claim 19, wherein the at least one processor is configured to call the at least one computer instruction to collect the configuration information of the system in at least one of the following ways:
collecting configuration information of the system from at least two devices in the system respectively;
collecting configuration information of the system from at least one controller which controls an operating process of at least one device in the system;
collecting configuration information of the system from at least one control platform which controls an operating process of at least one device in the system;
receiving manually inputted configuration information of the system; and
collecting configuration information of the system from at least one auxiliary device, the auxiliary device being configured to at least one of monitor an operating state of at least one device in the system and collect information of at least one device in the system.

24. The apparatus of claim 23, wherein the configuration information comprises at least one of the following information:
description information of data produced during operation of at least one device in the system;
description information of at least one device in the system; process control information for controlling an operating process of at least one device in the system; and
information for describing logic for realizing a function of the system.

25. The apparatus of claim 11, wherein the configuration information comprises at least one of the following information:
description information of data produced during operation of at least one device in the system;
description information of at least one device in the system; process control information for controlling an operating process of at least one device in the system; and
information for describing logic for realizing a function of the system.

26. The apparatus of claim 17, wherein the model adjusting module is further configured to:
update, after obtaining an adjusted model of the system, the training rule according to the adjusted model of the system.

27. A non-transitory computer readable medium, on which is stored at least one computer instruction which, when executed by a processor, causes the processor to execute the method of claim 2.
